(19) United States
(12) Patent Application Publication
(10) Pub. No.: US 2003/0063231 A1
(43) Pub. Date: Apr. 3, 2003

(54) LCD panel integrated with oled

(76) Inventors: Yuan-Tung Dai, Chungli City (TW); Tsung-Neng Liao, Taichung Hsien (TW)

Correspondence Address: BIRCH STEWART KOLASCH & BIRCH, PO BOX 747, FALLS CHURCH, VA, 22040-0747, US

(21) Appl. No.: 09/964,756

(22) Filed: Sep. 28, 2001

(51) Int. Cl. G02F 1/1335

(52) U.S. Cl. 349/61

(57) ABSTRACT

A color LCD panel in which a plurality of OLED are formed on the upper surface of the lower panel of the color LCD panel to be the back light source of the color LCD panel is disclosed in the invention. Each individual OLED corresponds to a pixel of the LCD panel in order to be the independent self-emitting light source of the pixel. Each OLED is always on and ready to emit one of the three primary colors, red, green, or blue. Thus, every pixel of the color LCD panel has its independent self-emitting light source. Therefore, the back light module and color filter in conventional color LCD panels are not needed.

### BACKGROUND OF THE INVENTION

1. Field of the Invention

The present invention relates to a liquid crystal display (LCD) panel, and especially to a liquid crystal display panel that integrates every pixel with OLED (Organic Light Emitting Diode) as a light source for the liquid crystal display.

2. Related Art

As planar display techniques are improved, liquid crystal displays are increasingly applied to products such as personal computers, TVs, and the like. As shown in FIG. 1, the cross sectional structure of one conventional color LCD panel comprises an upper polarizer 1, a liquid crystal structure 2, a lower polarizer 3, and a back light module 4. The liquid crystal structure 2 usually consists of an upper glass panel 5, a lower glass panel 6 (suitable spacing is created between the upper glass panel 5 and the lower glass panel 6), and liquid crystal material 12 filled in the space between the upper glass panel 5 and the lower glass panel 6. A color filter 7, a passivation layer 8, a first electrode layer 9 and an alignment layer 10 are sequentially formed on the lower surface of the upper glass panel 5. A second electrode layer 11 and a second alignment layer 12 are sequentially formed on the upper surface of the lower glass panel 6. According to the direction of the alignment layers 10 and 12, twisting alignment is created in liquid crystal molecules of the liquid crystal material. The color filter comprises a plurality of red, green, and blue color filtering films 71, and a black matrix 72 formed between the color filtering films 71. Each color filtering film 71 corresponds to a pixel. The passivation layer 8 is used to protect the color filter 7 and increase adhesion of the first electrode layer 9. The first electrode layer 9 and the second electrode layer 11 are made of transparent conducting material such as indium tin oxide. The electric field generated by the first electrode layer 9 and the second electrode layer 11 can be used to control the molecular arrangement of the liquid crystal material 13 and thus control the light switch of every pixel in the LCD panel. The back light module 4 is composed of a light guide 41 and edge lights 42 located at two edges of the light guide 41. Each edge light 42 is, for example, a CCFT (Cold Cathode Fluorescent Tube). A reflection layer 43 is formed on the lower surface of the edge light 41 to direct light generated by the edge light 42 up onto the liquid crystal structure and increase the utility rate of the back light module.

Comparing LCD panel and conventional CRT (Cathode Ray Tube) display panel, LCD is of higher resolution and has less volume and lower power consumption. Thus, new electronic products that utilize LCD panels are more compact and consume less power than they did before. However, there are still some drawbacks in conventional LCD panels. For example, a back light module such as the CCFT back light module is required for conventional color LCD panels. Because most of the light generated by the light source (cold cathode fluorescent tube) in the back light module is not used, the back light module cannot be used efficiently and thus has the problem of high power consumption. Furthermore, the back light module requires much space, which is unsuitable for compact sized color LCD panels. Furthermore, conventional color LCD panels use a filter to generate white light from the back light module and then transform it into the three primary colors of light (red, green, and blue). In this case, production cost increases and the light intensity of the color LCD panel decreases.

Therefore, it is necessary to have a new LCD panel to overcome conventional problems mentioned above.

### SUMMARY OF THE INVENTION

Accordingly, the object of the invention is to provide a high utility rate, power saving, high light intensity LCD panel to solve the problems of conventional LCD technology, such as low utility rate of the back light module and excessive consumption of power.

Another object of the invention is to provide a thinner LCD panel without using a large back light module.

Another object of the invention is to provide an LCD panel with individual pixels that have independent color self-emitting light sources. Conventional back light modules and color filters are not needed, which reduces material cost.

According to the objects mentioned above, the invention integrates the LCD panel with an OLED to provide the back light required by the LCD panel and substitute conventional back light modules.

According to the color LCD panel of the invention, a plurality of OLEDs are formed on the upper surface of the lower panel of the color LCD panel to be the back light source of the color LCD panel. Each individual OLED corresponds to a pixel of the LCD panel in order to be the independent self-emitting light source of the pixel. In this case, the CCFT back light module in conventional color LCD panels is not needed.

The OLED can be small molecule OLED or PLED (polymer light emitting diode). Under normal operational conditions, each OLED is always on and ready to emit the three primary colors, which are red R, green G, or blue B. Thus, every pixel of the color LCD panel has its independent self-emitting light source. The emitted light can be used directly without additional consumption. Therefore, the light utility rate and light intensity of the LCD panel is improved.

Because the color LCD panel doesn't have a large volume and power consuming CCFT back light module, it can be of a smaller volume and consume less power. The color LCD panel of the invention is also lower cost because the color filter of conventional LCD panels is not needed.

A LCD panel with in-plan switching LCD technology is used to illustrate the color LCD panel of the invention, but the application of the color LCD panel of the invention is not limited in the in-plan switching LCD. The invention can also be applied to TN (Twisted Nematic), STN (Super Twisted Nematic) or TFT (Thin Film Transistor) LCD panels. The color LCD panel consists of an upper panel, a lower panel 6 (suitable spacing is created between the upper panel and the lower panel), and liquid crystal material filled in the space between the upper panel and lower panel. A plurality of OLED are formed on the upper surface of the lower panel. Each individual OLED corresponds to a pixel of the color LCD panel. Under normal operation conditions, each OLED is always on and ready to emit the three primary colors, red R, green G, or blue B, in order to be the independent back light source of the pixel. A first polarization layer is formed on the plurality of OLED so the light generated by OLED can be polarized in one single direction. A second polarization layer is formed on the upper surface of the upper panel to be an analyzer. A plurality of transparent electrodes and an alignment layer are formed on the lower surface of the upper panel. The alignment layer enables the liquid crystal material between the upper panel and the lower panel to be aligned in a direction corresponding to the alignment layer. The transparent electrodes are used to provide the liquid crystal material with in-plane switching in order to control the direction of the liquid crystal material. Therefore, every pixel of the color LCD panel can be switched on/off and light intensity can be controlled.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given herein below. However, the following description is for purposes of illustration only, and thus is not limitative of the invention, wherein:

FIG. 1 illustrates the cross sectional structure of a conventional color LCD panel, which uses a back light module to be a back light source.

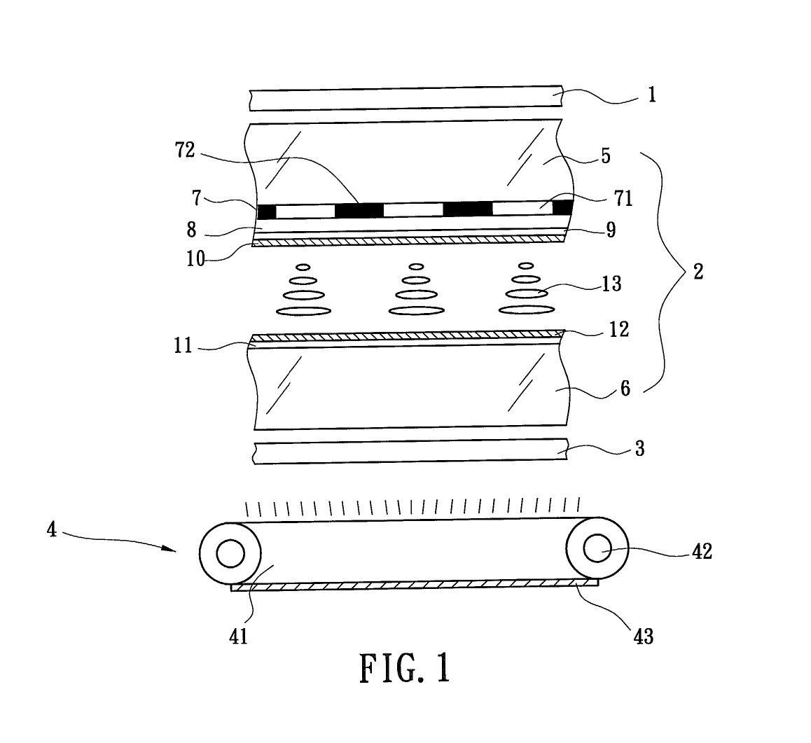

FIG. 2 illustrates the cross sectional structure of a LCD panel integrated with OLED in the invention.

### DETAILED DESCRIPTION OF THE INVENTION

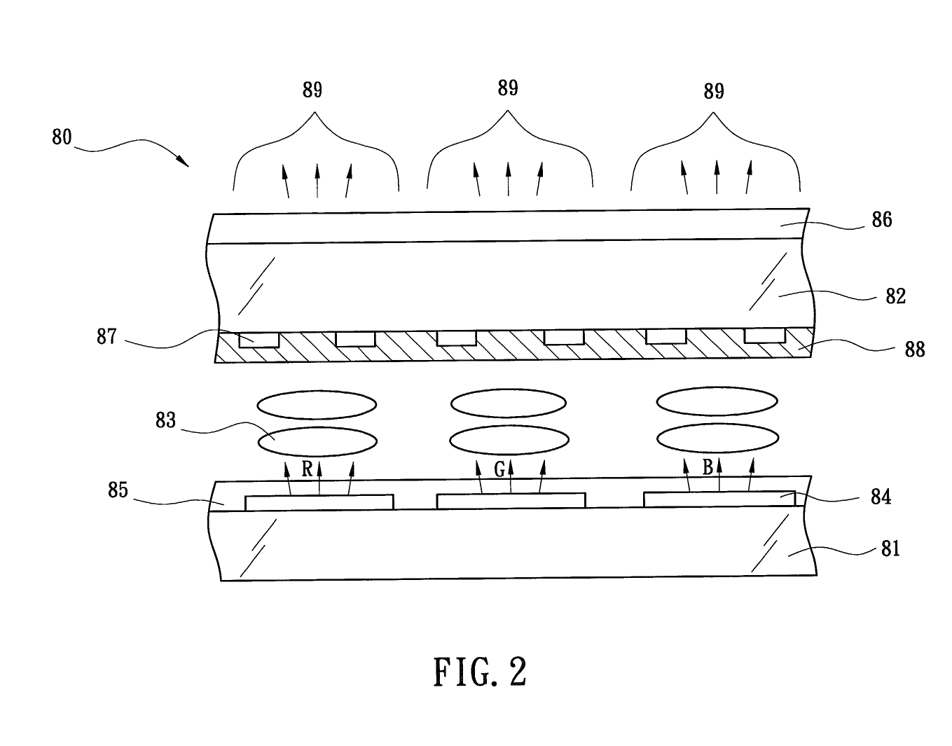

FIG. 2 shows a color LCD panel 80 of the invention using in-plan switching LCD technology. However, the invention is not limited to an in-plan switching LCD, as it can also be applied to TN (Twisted Nematic), STN (Super Twisted Nematic), TFT (Thin Film Transistor) LCD panels, or other suitable LCD panels.

The color LCD panel consists of a lower panel 81 and an upper panel 82 located above the lower panel 81. Suitable spacing is maintained between the upper panel 82 and the lower panel 81, which is, for example, 2-5 μm. Liquid crystal material 83 is filled in the space between the upper panel 82 and the lower panel 81. The lower panel 81 can be a transparent glass panel, nontransparent glass panel, silicon substrate, or plastic board. The upper panel 82 is composed of transparent material such as glass or plastic.

A plurality of OLED 84 are formed on the upper surface of the lower panel 81. Each individual OLED 84 corresponds to a pixel 89 of the color LCD panel 80. The OLED 84 can be composed of any suitable small molecule OLED or PLED (polymer light emitting diode). The structure and light emitting theory should be well understood by those who are familiar with this technique, so it is not described in detail here. Under normal operation conditions, each OLED 84 is always on and ready to emit any one of the three primary colors, red R, green G, or blue B, in order to be an independent back light source corresponding to the pixel 89. As shown in FIG. 2, the OLED 84 on the left hand side emits red light R, the middle one emits green light G, and the one on right side emits blue light B. The OLED 84 can be manufactured by a spin coating process or inject printing of PLED materials, which allows the OLED materials to be coated on the upper surface of the lower panel 81. The coated OLED materials are then patterned. The OLED 84 can also be formed by shadow mask and evaporation processes of small melocule OLED materials. The OLED 84 can also be formed by a combination of photolithography and etching, which are generally used in the semiconductor industry.

A first polarization layer 85 is formed on the plurality of OLED 84 so the light R, G, B generated by OLED can be polarized in one single direction. The first polarization layer 85 can be formed on the plurality of OLED 85 by an evaporation process. A second polarization layer 86 is formed on the upper surface of the upper panel 82 to be an analyzer. Similarly, the second polarization layer 86 can be formed by an evaporation process or by sticking a polarization board on the upper panel 82.

A plurality of transparent electrodes 87 and an alignment layer 88 are formed on the lower surface of the upper panel 82 to cover the transparent electrode 87 and the lower surface of the upper panel 82. The material of the transparent electrode 87 can be ITO (Indium Tin Oxide). The material of the alignment layer 88 can be polyimide. The alignment layer 88 enables the liquid crystal material 83 between the upper panel 82 and the lower panel 81 to be aligned in a direction corresponding to the alignment layer 88. Every two of the transparent electrodes 87 correspond to one pixel 89 of the color LCD panel 80, which means that every two of the transparent electrodes 87 correspond to one OLED 84. The transparent electrodes 87 are connected to a driver circuit (not shown in the drawing) formed on the lower surface of the upper panel 82 to provide in-plane switching for the liquid crystal material 83. In-plane switching means that the molecular axis of the liquid crystal material 83 can be rotated so the on/off state and light intensity of every pixel in the color LCD panel 80 can be controlled. The transparent electrodes 87 can be designed in a comb structure or other suitable electrode structure.

The invention being thus described, it will be obvious that the same may be varied in many ways. For example, the color LCD panel in the above embodiment can be not only in-plane switching, but also can be applied to other technologies. The transparent electrode and the driver circuit can be formed not only on the upper panel, but can also be formed on both the lower surface of the upper panel and the upper surface of the lower panel simultaneously. Such variations are not to be regarded as a departure from the spirit and scope of the invention, and all such modifications as would be obvious to one skilled in the art are intended to be included within the scope of the following claims.

What is claimed is:

1. A LCD panel integrated with OLED comprising, a suitable spacing kept between an upper panel and a lower panel, and a liquid crystal material filled between said upper panel and said lower panel, characterized in that a plurality of OLED are formed on the upper surface of said lower panel, each of said OLED is corresponded to a pixel in order to be an independent light source of said pixel.

2. A LCD panel integrated with OLED of claim 1, wherein said plurality of OLED are always on.

3. A LCD panel integrated with OLED of claim 2, wherein each of said OLED emits red color, green color, or blue light, and three neighboring OLED emit lights of different colors.

4. A LCD panel integrated with OLED of claim 1, wherein said OLED is small molecule OLED.

5. A LCD panel integrated with OLED of claim 1, wherein said OLED is PLED.

6. A LCD panel integrated with OLED of claim 1, wherein said lower panel is transparent glass panel.

7. A LCD panel integrated with OLED of claim 1, wherein said lower panel is silicon substrate.

8. A LCD panel integrated with OLED of claim 1, wherein said lower panel is plastic board.

9. A LCD panel integrated with OLED of claim 1, wherein said upper panel is transparent glass panel.

10. A LCD panel integrated with OLED of claim 1, wherein said upper panel is plastic board.

11. A LCD panel integrated with OLED of claim 1, wherein said LCD panel is in-plan switching LCD.

12. A LCD panel integrated with OLED of claim 11, wherein a plurality of transparent electrodes are formed on the lower surface of said upper panel to provide in-plan switching to said liquid crystal material and an alignment layer is formed on said plurality of transparent electrodes and the lower surface of said upper panel.

13. A LCD panel integrated with OLED of claim 12, wherein said plurality of transparent electrodes are make of indium tin oxide.

14. A LCD panel integrated with OLED of claim 1, further comprises a first polarization layer formed on said plurality of OLED, and a second polarization layer formed on the upper surface of said upper panel.
